(19) United States
(12) Patent Application Publication
(10) Pub. No.: US 2013/0159122 A1
(43) Pub. Date: Jun. 20, 2013

(54) OPTIMIZER AS AN APPSTORE SERVICE

(71) Applicants: Surupa Biswas, Bellevue, WA (US); Patrick Dussud, Redmond, WA (US); Andrew J. Pardoe, Bellevue, WA (US); Subramanian Ramaswamy, Redmond, WA (US)

(72) Inventors: Surupa Biswas, Bellevue, WA (US); Patrick Dussud, Redmond, WA (US); Andrew J. Pardoe, Bellevue, WA (US); Subramanian Ramaswamy, Redmond, WA (US)

(73) Assignee: MICROSOFT CORPORATION, Redmond, WA (US)

(21) Appl. No.: 13/327,074

(22) Filed: Dec. 15, 2011

(51) Int. Cl. G06Q 30/06; G06F 9/45

(52) U.S. Cl. 705/26.1

(57) ABSTRACT

Delivering applications to devices. A method includes receiving, at an AppStore, developer provided application code. The method further includes determining anticipated usage of an application based on the application code at end user devices. The method further includes using the determined anticipated usage, optimizing the developer provided application code at the AppStore to optimize for the anticipated usage. The method further includes delivering the optimized application code from the AppStore to an end user device anticipated to use the optimized application code according to the anticipated usage

### BACKGROUND

Background and Relevant Art

Computers and computing systems have affected nearly every aspect of modern living. Computers are generally involved in work, recreation, healthcare, transportation, entertainment, household management, etc.

Further, computing system functionality can be enhanced by a computing system's ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

The prevalence of widely connected systems has allowed distribution of software and data in an efficient and economical manner. For example, systems can purchase and obtain software directly from network, such as the Internet. Recently, web site hosed application market places, known as AppStores have become an increasingly common way to distribute and deploy software applications.

There is some difficulty when delivering applications via an AppStore. In particular, applications delivered from an AppStore are often delivered to mobile devices such as mobile phones or tablets. There are many devices available each having its own characteristics. Thus, it is possible to optimize software for a particular device. As such, AppStores will often have different versions of a single application for different devices that may attempt to purchase the application from the AppStore. These different versions are provided by the developer of the application based on what devices the developer anticipates the application will be used on. However, users are limited to what versions are on the AppStore, such that sometimes an appropriate version will not be available or will not be optimized for a particular device.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein is directed to a method of delivering applications to devices. The method includes receiving, at an AppStore, developer provided application code. The method further includes determining anticipated usage of an application based on the application code at end user devices. The method further includes using the determined anticipated usage, optimizing the developer provided application code at the AppStore to optimize for the anticipated usage. The method further includes delivering the optimized application code from the AppStore to an end user device anticipated to use the optimized application code according to the anticipated usage.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an AppStore environment where application code can be uploaded from a developer to an AppStore and optimized/or compiled at the AppStore; and

FIG. 2 illustrates a method of delivering applications.

### DETAILED DESCRIPTION

Distributing software through an AppStore enables opportunities to offload traditional compilation and optimization tasks to machines in the cloud associated with AppStores that can perform these operations, potentially with greater ease, efficiency, flexibility and reliability

For example, in some embodiments, compilers and optimizers that might ordinarily run on a developer's machine or on the client/end-user device where the application runs can be instead run on machines in the AppStore.

In some embodiments, this may be useful in that often, machines in the AppStore are likely to be more powerful than a standard development machine or client device. Thus compilers and optimizers can run more efficiently, perform more sophisticated, resource-intensive and longer latency operations, and/or attempt optimizations that typically wouldn't have been attempted were a user compiling the application locally and waiting for compilation to finish.

In some embodiments, developers can submit applications in formats that are verifiable. A trusted, centralized service in the AppStore can further optimize the applications to deliver optimized applications to end-users. Optimization may include one or more of optimizing for increased performance, application size to reduce memory footprint, reduced power consumption, etc.

In some embodiments, AppStores can abstract away from the application developer the complexity of handling different device types and offer more flexibility. For example, the AppStore optimizer may choose to deploy applications in a higher-level, but more compact, format to devices that are memory-constrained. The AppStore optimizer may choose to deploy applications as lower level formats such as native code to other devices that are not as resource-constrained and need raw performance.

Embodiments may be implemented where an AppStore can “automatically” re-compile and re-optimize applications for all end user devices in the ecosystem as they change. For example, embodiments can support new processor types, deploying platform updates, new devices with different characteristics, etc.

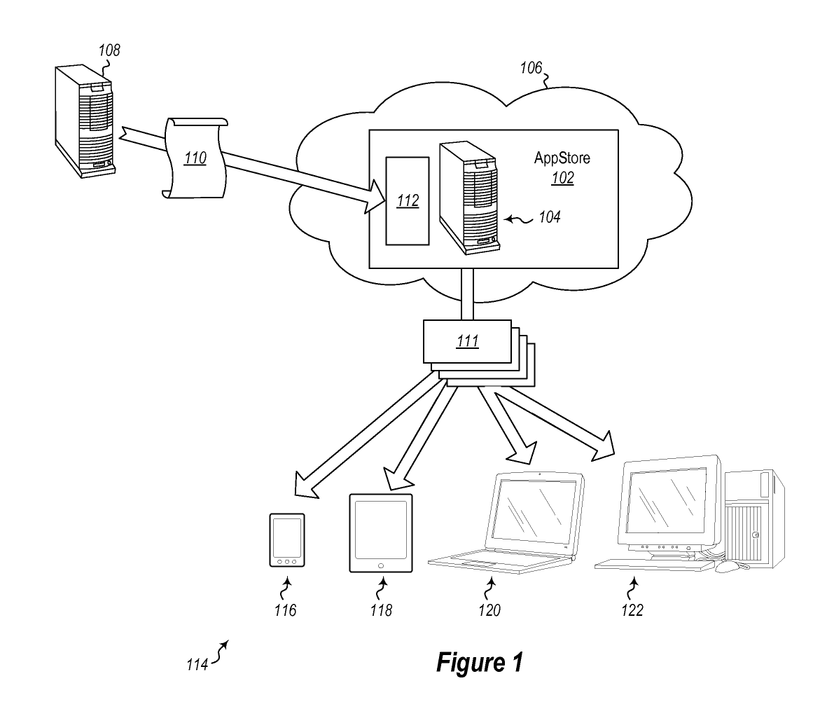

Referring now to FIG. 1, an example embodiment is illustrated. FIG. 1 illustrates an AppStore 102. The AppStore 102 may include a number of machines 104, such as server machines or other machines. Embodiments can leverage these machines 104 in the cloud 106 to perform compiler and post-compilation optimizations for AppStore applications.

FIG. 1 further illustrates a developer machine 108. Developers can submit application code 110 from the developer machine 108 in formats that can be verified via static analysis tools 112 and then using a trusted service in the cloud to deploy the applications 111 in unverifiable, but optimized formats. Alternatively or additionally, in some embodiments, such as cases where the application is authored in C, C++, etc., static analysis tools 112 can be used to ensure that code is only using the subset of operating system and device functionality approved for use by applications.

Some embodiments allow developers to work in an IDE (Interactive Development Environment) from where they can connect to a “compiler service” that runs their compilation task on machines 104 in the AppStore 102.

Some embodiments allow developers to leverage services in the AppStore 102 to abstract developers from having to deal with differences in a device ecosystem. For example, a device ecosystem may include devices with different platform stacks and different processor architectures, among other things. For example, FIG. 1 illustrates a set of devices 114. In the set of devices are a cellular telephone 116, a tablet computing device 118, a laptop computer 120, and a desktop computer 122. Each of these devices may have differing operating systems, platform stacks, processor architectures, connectivity features, etc. Further, it should be appreciated that even different devices within a same class may have such differences. For example, different cellular telephones may be vastly different in terms of operating system and/or processor architecture. However, embodiment allow a developer to have a more uniform development experience irrespective of what device an application 111 is eventually downloaded and executed on.

Embodiments may include functionality for leveraging services in the AppStore 102 to minimize the amount of processing that happens on an end-user device, such as one or more devices in the set of devices 114, to run applications 111. For example, instead of dynamically compiling applications distributed in a high-level intermediate format, applications can be compiled to native code for a device platform or lower-level intermediate formats in the AppStore 102 thereby reducing the amount of processing performed on a given end-user device.

Embodiments may include functionality for leveraging services in the AppStore 102 to rapidly evolve tools such as compilers and optimizers. This can be done by centralizing compilers and optimizers at the AppStore 102. In particular, implementing compilers and optimizers in a centralized fashion at the AppStore 102 allows them to be evolved at a faster rate than a rate at which they might evolve if they were distributed broadly. For example, when compilers and optimizers are distributed broadly (e.g., each developer maintains their own instances of compilers and optimizers) widespread support and maintenance may slow the rate at which compilers and optimizers can evolve due to the time and resources expended for updating in a widespread fashion. In particular, significant network resources may be needed to push updates to each the various developers. Further, significant time may be needed to ensure that each of the developers receive the update. Further still, feedback about updates may take longer to receive as the updates themselves take longer to deploy.

The following illustrates a workflow example of a system that may be implemented in some embodiments. A developer may author an application at a developer machine 108 in a programming language such as C#, VB, Java etc. The application code 110 is compiled to a verifiable intermediate format such as for example, in one embodiment, MSIL available from Microsoft® Corporation of Redmond Wash., on the developer's machine 108. The application code 110 in the verifiable format is then submitted to an AppStore 102/application market place. The AppStore 102 checks the application code 110 in a variety of ways. It also verifies that the application does not perform any unsafe operations. For example, in some embodiments such verification may take place using tools such as PEVerify available at http://msdn.microsoft.com/en-us/library/62bwd2yd(VS.80).aspx from Microsoft® Corporation of Redmond Wash.

The AppStore 102 may perform a variety of optimizations on the developer submitted-application code 110. For example, the AppStore 102 could compile the application code 110 into a different, lower-level format. Alternatively or additionally, the AppStore 102 could compile the application code 110 all the way down to native code (i.e. machine instructions) for the various devices 114 on which the application 111 will be executed. The optimized and/or further compiled application 111 can be made available for download to end-user devices 114.

The AppStore 102 could make different versions of a developer-submitted application available to different classes of devices in the ecosystem. These different versions could be deployed transparently to both the end-user at a particular device and to the developer submitting application code 110. For example, when downloaded for a tablet device versus a low-end phone, the application 111 may be available in a different format (e.g., one optimized for better performance for the tablet device, the other for minimized storage for the low-end phone).

As another example, when downloaded on a high bandwidth connection, the application 111 could be provided in a format that is less compact but better optimized for raw performance. On a low bandwidth connection, it could be provided in a compact format that minimizes download time but is not as optimized and/or requires more processing on the end-user device.

As yet another example, devices in an ecosystem could have different processor architectures. For example, some devices may be Intel® processor-based while others could be ARM®-based. Some devices may have support for single instruction multiple data (SIMD) operations, others may not. The AppStore 102 could provide suitable optimized versions for the various targets in the ecosystem without requiring the developer to build multiple versions of their application. Rather, the AppStore 102 could compile application code 110 to appropriate application 111 versions before delivering the code to the devices.

Devices in the ecosystem could be using different versions of a platform stack. For example, some device may use the Windows® Phone 7 stack while others use newer or different versions of the Windows® Phone stack. The different versions of a platform stack may have different libraries and application frameworks. Assuming all capabilities used by an application are supported on the different versions, the AppStore 102 can compile application code 110 against the different sets of libraries and make the application 111 available to all end-users regardless of the version of the platform stack on their device.

Note that while some examples above indicate that the application code 110 is compiled by the developer to a verifiable intermediate format, that isn't strictly necessary. Applications authored in languages such as C, C++ and Objective C could also be submitted to the AppStore 102 and optimized thereafter for aspects such as download size vs. application performance. In some such embodiments, static analysis could be used to ensure that code is only using the subset of operating system and device functionality approved for use by applications.

Some embodiments may be implemented where application code 110 is compiled in a just in time format. For example, when new device types (e.g., devices having different architectures, operating systems, application libraries, etc.) are detected, application code 110 can be optimized and compiled for these newly discovered devices at the AppStore.102. For example, a device of a previously unknown device type may request an application 111 from the AppStore 102. While the AppStore 102 may not have a version of the application 111 suitable for the device, either as a functional version or an optimized version, the App Store 102 could create an appropriate version as a result of the request from the device, and provide the version to the device. This could significantly reduce the amount of time required to make versions of an application available to most devices and reduce frustration at a user level due to not having appropriate versions available.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

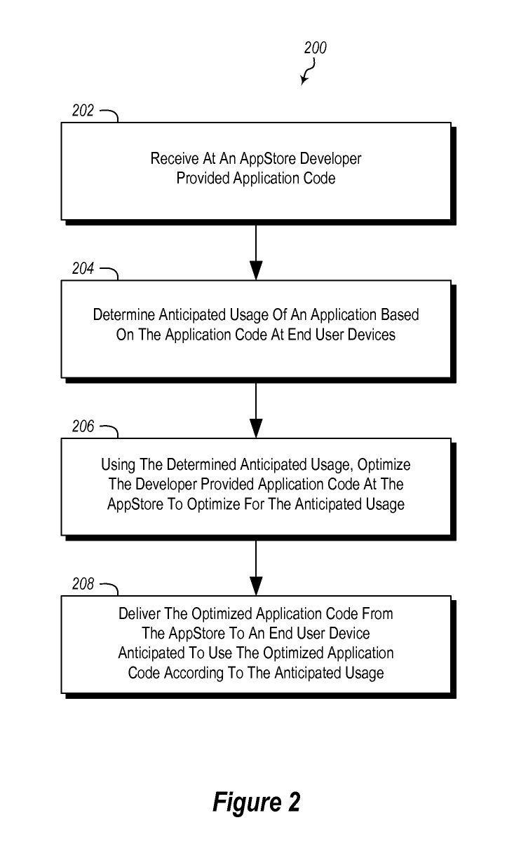

Referring now to FIG. 2, a method 200 is illustrated. The method 200 includes acts for delivering applications to devices. The method 200 includes receiving at an AppStore developer provided application code (act 202). For example, FIG. 1 illustrates the AppStore 102 receiving application code 110 from a developer machine 108.

The method 200 further includes determining anticipated usage of an application based on the application code at end user devices (act 204). Determining an anticipated usage may include one or more of a number of different factors as described in more detail below.

The method 200 further includes using the determined anticipated usage, optimizing the developer provided application code at the AppStore to optimize for the anticipated usage (act 206). Optimizations may take a number of different forms as described above and in more detail below. For example, an optimization may be one which in a cellular telephone example optimizes application code to conserve bandwidth for delivery of the application, such as for example when the application 111 is delivered over cellular data networks. This may result in the cellular telephone being required to perform additional compilation or optimization activities. Alternatively, when high bandwidth delivery paths are available, such as over wired or wireless broadband connections, optimization may include fully compiling application code with no or minimal effort on reducing the size of a deliverable package including the application code.

The method 200 further includes delivering the optimized application code from the AppStore to an end user device anticipated to use the optimized application code according to the anticipated usage (act 208). For example, as illustrated in FIG. 1, the AppStore 102 delivers the application 111 in various formats appropriate to each of the devices in the set of devices 114.

For example the anticipated usage may be based on a particular device platform. For example, the AppStore 102 could determine that an application 111 is to be deployed to various platforms such as desktop platforms, tablet platforms, cellular phone platforms, or even different platforms including different operating systems within a device category. The application code 110 could be optimized at the AppStore 102 to optimize the application code 110 for the different devices in the set of devices 114 to which an application 111 will be delivered.

Alternatively or additionally, the anticipated usage is based on a preferred workflow for interacting with the application. For example, a user or device may prefer a particular method of interacting with an application 111. Such preferences can be indicated to the AppStore 102 which causes the AppStore 102 to optimize compilation of the application code 110 for use with the particular workflow indicated in the preferences indicated to the AppStore 102.

Alternatively or additionally, the anticipated usage is based on device settings or configuration. For example, a device from among the set of devices 114 may be able to communicate to the AppStore 102 various settings, such as communication settings, display settings, automatic update settings, sharing settings, cloud based storage settings, etc. These settings can be used by the AppStore to compile and the optimize application code 110 appropriate to the device settings on a particular device.

Alternatively or additionally, the anticipated usage is based on processor architecture. For example, some devices may use an Intel® processor architecture whereas other devices use an ARM® processor architecture. Application code 110 may be compiled at the AppStore 102 to optimize for the different architectures of devices in the set of devices 114.

Alternatively or additionally, the anticipated usage is based on instruction support. For example, different devices may implement different versions of an operating system which have different libraries. With this knowledge, the AppStore 102 can compile the application code 110 to optimize for the different libraries on the different devices on the set of devices 114.

Alternatively or additionally, the anticipated usage is based on usage as trusted code as between the AppStore and the end user device. For example, the AppStore may only want to accept applications from developers in formats that can be verified. Once the developer provided application has been verified, it can be processed by AppStore services (written by a “trusted 1^{st} party”) to generate an optimized version of the application that does not need further verification on the end-user device. As another example, application signatures (such as Authenticode or strong-name signatures) can be checked in the AppStore and need not be checked again on the end-user device.

The method 200 may be practiced where optimizing the developer provided application code includes compiling the code down to native machine code. Alternatively, the method 200 may be practiced where optimizing the developer provided application code includes compiling the code down to a lower level intermediate format code. In this case, the device from among the set of devices 114 to which the application 111 was delivered would do some additional processing to compile the application 111 to native machine code.

The method 200 may further include updating a compiler for compiling the developer provided application code by only providing new compiler code to AppStores and specifically not providing new compiler code to developers and/or end-user devices. This can simplify the process of fixing compiler bugs or problems. In particular, by using a centralized compiler, rather than having individual compiler instances being used by individual developers, the centralized compiler can be upgraded or repaired in a simpler fashion than would need to be done to repair or upgrade multiple instances of a compiler. Similarly, fixes for a particular device (such as a particular handset model) could be made at the AppStores without requiring individual developers to make changes to a compiler for individual handsets.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of delivering applications to devices, the method comprising:
receiving at an AppStore developer provided application code;
determining anticipated usage of an application based on the application code at end user devices;
using the determined anticipated usage, optimizing the developer provided application code at the AppStore to optimize for the anticipated usage; and
delivering the optimized application code from the AppStore to an end user device anticipated to use the optimized application code according to the anticipated usage.

2. The method of claim 1, wherein the anticipated usage is based on a particular device platform.

3. The method of claim 1, wherein the anticipated usage is based on a preferred workflow for interacting with the application.

4. The method of claim 1, wherein the anticipated usage is based on device settings or configuration.

5. The method of claim 1, wherein the anticipated usage is based on processor architecture.

6. The method of claim 1, wherein the anticipated usage is based on instruction support.

7. The method of claim 1, wherein the anticipated usage is based on usage as trusted code as between the AppStore and the end user device.

8. The method of claim 1, wherein optimizing the developer provided application code comprises compiling the code down to native machine code.

9. The method of claim 1, wherein optimizing the developer provided application code comprises compiling the code down to a lower level intermediate format code.

10. The method of claim 1, wherein optimizing the developer provided application code comprises compiling the code to optimize for reduced power consumption.

11. The method of claim 1, wherein optimizing the developer provided application code comprises compiling the code to reduce memory footprint.

12. The method of claim 1 further comprising, updating a compiler for compiling the developer provided application code by only providing new compiler code to AppStores while specifically excluding updates directly to developers.

13. One or more computer readable media comprising computer executable instructions that when executed by one or more processors cause the one or more processors to perform the following:
receiving at an AppStore developer provided application code;
determining anticipated usage of an application based on the application code at end user devices;
using the determined anticipated usage, optimizing the developer provided application code at the AppStore to optimize for the anticipated usage; and
delivering the optimized application code from the AppStore to an end user device anticipated to use the optimized application code according to the anticipated usage.

14. The one or more computer readable media of claim 11, wherein the anticipated usage is based on a particular device platform.

15. The one or more computer readable media of claim 11, wherein the anticipated usage is based on a preferred workflow for interacting with the application.

16. The one or more computer readable media of claim 11, wherein the anticipated usage is based on device settings or configuration.

17. The one or more computer readable media of claim 11, wherein the anticipated usage is based on processor architecture.

18. The one or more computer readable media of claim 11, wherein the anticipated usage is based on instruction support.

19. The one or more computer readable media of claim 11, wherein the anticipated usage is based on usage as trusted code as between the AppStore and the end user device.

20. A computing system configured to send or receive messages in a host agnostic way in a continuation based runtime, the system comprising:
one or more processors;
one or more computer readable media coupled to the one or more processors, wherein the one or more computer readable media comprise computer executable instructions that when executed by one or more of the one or more processors cause one or more of the one or more processors to perform the following:
receiving at an AppStore developer provided application code;
receiving, at the AppStore, a request from a device for an application based on the application code;
determining, at the AppStore, characteristics of the device requesting the application based on the application code;
at the AppStore, using the determined characteristics of the device, compiling the application code to optimize the application code for the device; and
delivering the optimized application code from the AppStore to the device to use the optimized application code.
